(19) United States
(12) Patent Application Publication
(10) Pub. No.: US 2012/0042996 A1
(43) Pub. Date: Feb. 23, 2012

(54) Carrying bag with solar cell phone recharger and lighting

(76) Inventor: Kenneth P. Glynn, Flemington, NJ (US)

(21) Appl. No.: 12/806,615

(22) Filed: Aug. 17, 2010

(51) Int. Cl. A45C 13/00; E05B 17/10; H01M 10/46

(52) U.S. Cl. 150/106; 320/101; 362/100; 190/124

(57) ABSTRACT

A carrying bag includes: (a) a main carrying bag housing having an inside storage compartment and having an access opening to the inside storage compartment; (b) a solar panel located on an outside of the housing and wiring from the solar panel to a solar power storing and recharging system located within the inside storage compartment; (c) the solar power storing and recharging system located within the storage compartment having at least a voltage regulator and a storage battery, the storage battery and voltage regulator having sufficient capacity and voltage regulation for charging a cell phone and for powering a keyhole light; (d) at least one cell phone connection wire and adaptor for recharging a cell phone, the wire and adaptor connected to the solar power storing and recharging system and located within the inside storage compartment; (e) a keyhole light connected to the solar storing and recharging system and connected to the main carrying bag housing and having on/off switch, the keyhole light being located in a functional position selected from the group consisting of (i) fixed within the main carrying bag housing so that light is directed outwardly therefrom; and (ii) removably stored for manual use.

### BACKGROUND OF INVENTION

a. Field of Invention

The invention relates generally to biodegradable wound care products with biocompatible artificial skin treatments. More specifically, the present invention relates to bandages comprised of a biodegradable support member, a biodegradable adhesive, a biodegradable actives carrier and an active ingredient. The active ingredient is intended to assist in the healing process of wounds and includes a layer of biocompatible algae artificial skin including sterilized water and at least sixty percent by weight of reconstituted seaweed. Brown Laminaria seaweed may be used for its desirable polyfucose sulfate content. The active ingredient is prepared by first drying the raw materials, converting the raw materials to a powder and then reconstituting the powder with sterilizes water.

b. Description of Related Art

The following patents are representative of the field pertaining to the present invention:

U.S. Pat. No. 6,977,479 B2 to Hsu. describes a portable, cellular phone battery charger using solar energy as the primary source of power and including two separate solar panels and a battery/switch containing unit. The two panels are hingedly connected together, and the battery/switch containing unit is hingedly connected to the back side of one of the panels. The assembly is pivotable between a retracted configuration in which the three component parts lie in parallel planes, and a deployed configuration in which the two solar panels lie in one plane and the battery/switch unit lies in another plane angularly intersecting the solar panel plane. The device is selectively operable in three different modes; namely, a first mode in which the solar panels are connected to charge or power a cell phone; a second node in which the solar panels are connected to charge the device's internal battery, and a third mode in which the internal battery is used to charge or power a phone coupled to the device.

U.S. Pat. No. 6,504,340 B1 to Lee describes a hands-free kit for mobile phones using a solar cell. The hands-free kit has a solar cell, a charging unit, and a power switch. The solar cell is formed to be integrated with the body at a portion of the body of the hands-free kit and used to convert sunlight into electrical energy. The charging unit is formed at a portion within the body of the hands-free kit for charging one or more rechargeable batteries of the charging unit by power supplied from the solar cell. The power switch is formed at a portion of the body of the hands-free kit for allowing the rechargeable batteries to be connected in parallel with the solar cell and charged when the power switch is turned off, while allowing the rechargeable batteries to be connected in series with each other so as to convert a charged voltage into power for operating an internal circuit of the hands-free kit when the power switch is turned on.

U.S. Pat. No. 6,429,621 B1 to Arai describes a solar power charging system including: a voltage converter for converting a voltage level of all original voltage generated by a solar battery into generate a charging voltage and for charging a capacitor by the charging voltage; and a duty ratio control circuit electrically coupled to the voltage converter for supplying a driving clock to the voltage converter for allowing the voltage converter to operate based on the driving clock, wherein the duty ratio control circuit adjusts a duty ratio of the driving clock based on a maximum charge power which depends on the original voltage generated by the solar battery.

U.S. Pat. No. 4,912,611 to Lyle describes a handbag battery powered flashlight with a separate control switch that can be rapidly moved from handbag to handbag of either the rigid frame construction or the foldable fabric type. A control switch with actuating arms pressing against the sides of the handbag closing the switch contacts whenever the handbag is opened. Both the light source and the control switch having VELCRO, or similar material, for fastening to the interior surfaces of the handbag. A flexible electrical conductor connecting the light source to the control switch permits moving the light source to various locations for inspecting the external compartments of the handbag as well as illuminating the keyhole in a door or automobile ignition lock.

U.S. Pat. No. 4,379,935 to Castaldo describes an electrical arrangement for a handbag including a switch unit having at least one electrical terminal on its exterior, a magnetically responsive switch in its interior connected to the terminal, and a battery in the handbag connected to the terminal and to the magnetically responsive switch. The terminal is adapted to receive either an illumination device or an alarm device at the option of the handbag owner. A magnet is utilized in conjunction with my novel switch unit, with the switch unit being mounted on one interior wall of the handbag, and the magnet being mounted on another interior wall of the handbag in a position opposite, and in substantial alignment with, the switch unit. The magnet is supportable in at least two different positions on its mounting such that when in a first position it can interact with the magnetically responsive switch as the handbag is opened or closed, thus causing the illumination of a bulb or sounding of the alarm as the handbag is opened. However, when the handbag owner has moved the magnet to a second position, the magnet does not bring about a switching function as the handbag is opened, thus enabling the handbag owner to utilize an alarm circuit that will sound if the unattended bag is lifted off a surface upon which it has been resting, irrespective of the bag being open or closed. A number of different illumination circuits and alarm circuits are available at the option of the owner.

United States Application No. 2005/0219839 A1 to Branson describes a lighted purse that has an efficient light source, so as to prolong battery life. In one embodiment the purse includes a rechargeable battery for a purse light, and a recharging device such as a solar panel, so that the battery is recharged during normal use. The light source used is preferably a low temperature light source, such as a high efficiency miniature lamp bulb, or an electroluminescent strip. Also, a low voltage neon tube can also be used. In a preferred embodiment, the purse has an interior strip for distributing light, and at least one battery-powered light source. The interior strip preferably runs along the central interior bottom, sides, and top. For a zipper purse, the interior strip preferably runs along one side of the zipper. The interior strip is preferably attached to the purse interior using any conventional attachment means such as hook-and-loop fastener material.

United States Application No. 2005/0162121 A1 to Chan describes a multifunctional and portable solar charger, more particularly, a portable solar charger which combines the functions of charging, illumination and power supply together in order to perform effectively transform between a low voltage and a high voltage and conversion between chemical energy and electrical energy, when a storage battery of the charger is charged with the electrical energy, the electrical energy can be transferred to a mobile phone or its battery and other mini-type electrical apparatus such as digital camera, portable computer and portable CD player, in addition, the charger can be connected to an alternating current (AC) power supply.

United States Application No. 2004/0204179 A1 to Hsu describes a multi-socket solar energy converting battery charger for a mobile phone that is easily portable and capable of converting sunlight to electricity to charge the mobile phone. The battery charger comprises a case part and a over part that respectively mount solar panels. The battery charger further includes a circuit board that has a protection circuit, particular circuits, and a voltage stabilizing circuit to stabilize the charging voltage. The circuit board is further connected to a socket through which the battery charger connects a converter socket block to accommodate different types of mobile phones.

United States Application No. 2003/0128010 A1 to Hsu describes a cellular phone charging device including two separate solar panels and a battery/switch containing unit. The two panels are hingedly connected together, and the battery/switch-containing unit is hingedly connected to the backside of one of the panels. The assembly is pivotable between a retracted configuration in which the three component parts lie in parallel planes, and a deployed configuration in which the two solar panels lie in one plane and the battery/switch unit lies in another plane angularly intersecting the solar panel plane. The device is selectively operable in three different modes; namely a first mode in which the solar panels are connected to charge or power a cell phone; a second mode in which the solar panels are connected to charge its internal battery, and a third mode in which the internal battery is used to charge or power a phone coupled to the device.

Notwithstanding the prior art, the present invention is neither taught nor rendered obvious thereby.

### SUMMARY OF INVENTION

The present invention is directed to a carrying bag, which includes: (a) a main carrying bag housing having a top, a bottom, a front, a back, a left side and a right side, and having an inside storage compartment and having an access opening to said inside storage compartment; (b) a solar panel located on an outside area of said main carrying bag housing and wiring from said solar panel to a solar power storing and recharging system located within said inside storage compartment; (c) said solar power storing and recharging system located within said storage compartment having at least a voltage regulator and a storage battery, said storage battery and voltage regulator having sufficient capacity and voltage regulation for charging a cell phone and for powering a keyhole light; (d) at least one cell phone connection wire and adaptor for recharging a cell phone, said wire and adaptor connected to said solar power storing and recharging system and located within said inside storage compartment; (e) a keyhole light connected to said solar storing and recharging system and connected to said main carrying bag housing and having on/off switch, said keyhole light being located in a functional position selected from the group consisting of (i) fixed within said main carrying bag housing so that light is directed outwardly therefrom; and (ii) removably stored for manual use.

In some embodiments of the present invention carrying bag, said keyhole light is an LED light.

In some embodiments of the present invention carrying bag, said adaptor is a plurality of interchangeable adaptors for a variety of different cell phone charger connections.

In some embodiments of the present invention carrying bag, said carrying bag is selected from the group consisting of a pocketbook, a briefcase, a belt pouch, a beach bag and a backpack. Other carrying-bag formats may be used herein as well, such as purses, satchels, duffle bags, lunch carriers and the like.

In some embodiments of the present invention carrying bag, said main carrying bag housing has a closeable sub-storage enclosure for storing said solar power storing and recharging system within said inside storage compartment.

In some embodiments of the present invention carrying bag, said keyhole includes a flashing option with a corresponding flashing switch.

In yet other embodiments of the present invention carrying bag, any or all of the above-described features are included and the present invention carrying bag further includes an alarm connected to said solar storing and recharging system and connected to said main carrying bag housing and having on/off switch for activation and deactivation. In some of these embodiments of the present invention carrying bag, the alarm is a sounding alarm and includes a speaker. In others, the alarm is a visual alarm that includes at least one feature selected from the group consisting of colored light, flashing light and combinations thereof. In yet others, the alarm is a visual and sounding alarm that includes at least one feature selected from the group consisting of colored light, flashing light and combinations thereof and includes a speaker. In some of these embodiments of the present invention carrying bag, the alarm activation switch is activated with a time delay by opening said access opening of said housing without timely deactivating said alarm.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a diagrammatic presentation of various embodiments of the present invention;

FIG. 2 is a is a diagrammatic presentation of various embodiments of the present invention as shown in FIG. 1 and additionally including an alarm;

FIG. 3 is an oblique view of one embodiment of a present invention purse with a built-in LED light; and,

FIG. 4 is an oblique view of one embodiment of a present invention briefcase with a manually moveable LED light.

### DETAILED DESCRIPTION OF THE EMBODIMENTS

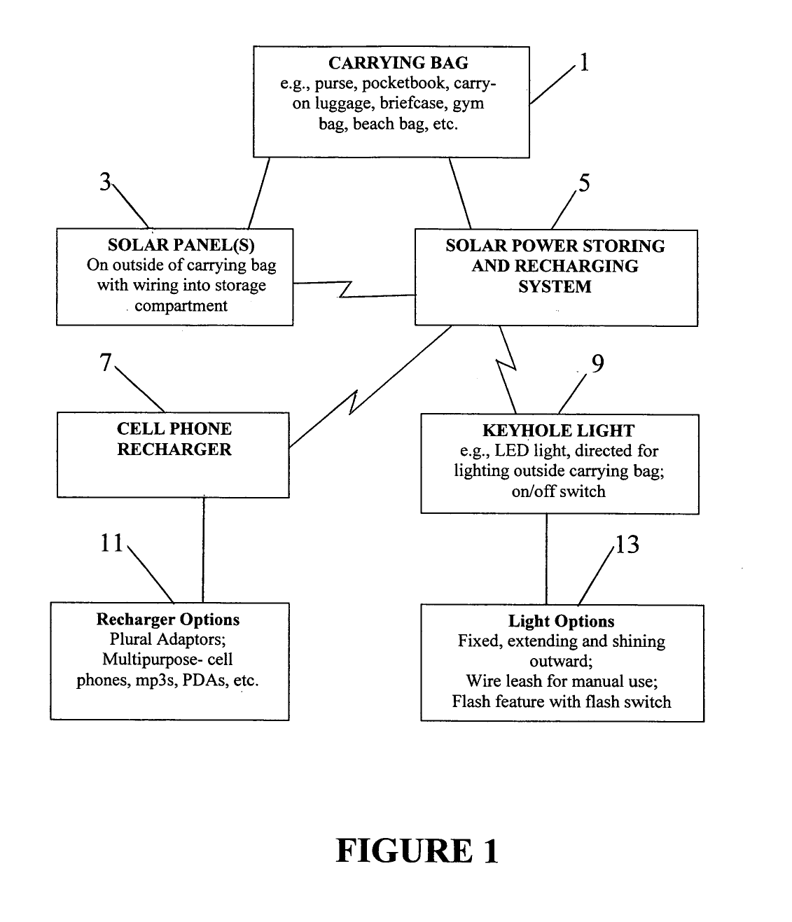

FIG. 1 is a diagrammatic presentation of various embodiments of the present invention. Carrying bag frame 1 may reference any bag of the type described anywhere herein, including but not limited to those specifically set forth in frame 1. Solar panel(s) frame 3 may be any conventional or developed solar panel(s) and they are mounted on the outside of the carrying bag frame 1. The solar panels are wired through the main housing of the carrying bag and provide electric energy to the solar power storing and recharging system frame 5, located inside the carrying bag housing and preferably in its own sub compartment. Cell phone charger frame 7 is also located inside the main housing and may have one or more adaptors for different cell phones or for cell phones and other different electronic devices, frame 11. A keyhole light frame 9 is included and is attached to the system of frame 5. It may be fixed or tethered (frame 13) and is located for use wherein the light is directed away from the carrying bag. Users may utilize the stored solar power for recharging the cell phone or PDA or mp3 or the like and/or for external illumination, as needed. The solar power storing and recharging system internals minimally have a voltage regulator and at least one battery, and various specific electronics details may be included that are well within the skills of the artisan, such as are described in the prior art references cited above.

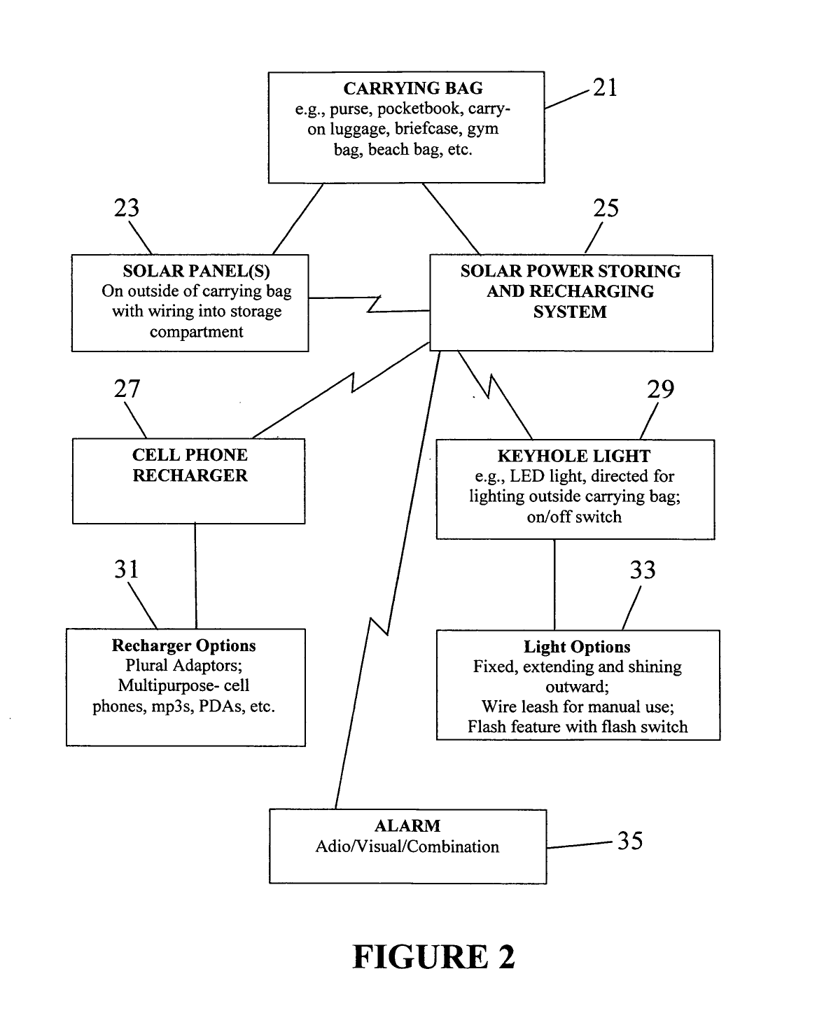

FIG. 2 is a is a diagrammatic presentation of various embodiments of the present invention as shown in FIG. 1 as are set forth in frames 21, 23, 25, 27, 29, 31, 33 and 37. Additionally an alarm (frame 35) is included. The alarm may be audio, visual or both, and may include color lights, blinking lights, alarm sounds, such as chips with siren or other alarm sounds.

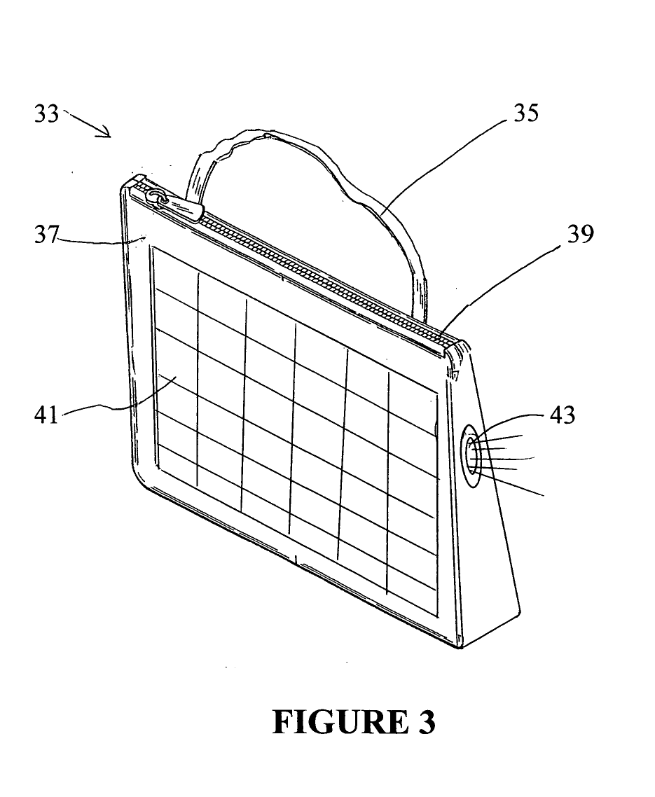

FIG. 3 is an oblique view of one embodiment of a present invention purse 33 with a handle 35. It has a built-in LED light 43 and a solar panel 41 on the purse main housing 37, for creating stored power for both the light and a cell phone charger inside the purse 33. Access opening 39 opens to the storage compartment wherein the solar power storing and recharging system is contained, as well as the light switch and the cell phone charger adapter.

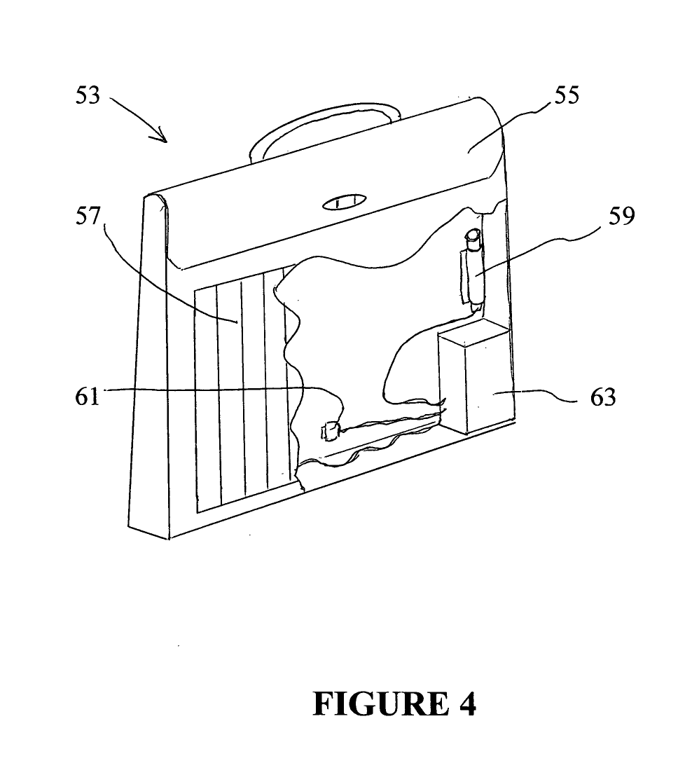

FIG. 4 is a partially cut oblique view of one embodiment of a present invention briefcase 53 with an access flap 55, a manually moveable LED light 59, a storage and recharging system 63, a cell phone recharger adapter 61 and a light controller (not shown). These are powered from the system 63, which is charged by attached solar panel 57.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A carrying bag, which comprises:
a) a main carrying bag housing having a top, a bottom, a front, a back, a left side and a right side, and having an inside storage compartment and having an access opening to said inside storage compartment;
b) a solar panel located on an outside area of said main carrying bag housing and wiring from said solar panel to a solar power storing and recharging system located within said inside storage compartment;
c) said solar power storing and recharging system located within said storage compartment having at least a voltage regulator and a storage battery, said storage battery and voltage regulator having sufficient capacity and voltage regulation for charging a cell phone and for powering a keyhole light;
d) at least one cell phone connection wire and adaptor for recharging a cell phone, said wire and adaptor connected to said solar power storing and recharging system and located within said inside storage compartment;
e) a keyhole light connected to said solar storing and recharging system and connected to said main carrying bag housing and having on/off switch, said keyhole light being located in a functional position selected from the group consisting of (i) fixed within said main carrying bag housing so that light is directed outwardly therefrom; and (ii) removably stored for manual use.

2. The carrying bag of claim 1 wherein said keyhole light is an LED light.

3. The carrying bag of claim 1 wherein said adaptor is a plurality of interchangeable adaptors for a variety of different cell phone charger connections.

4. The carrying bag of claim 1 wherein said carrying bag is selected from the group consisting of a pocketbook, a briefcase, a belt pouch, a beach bag and a backpack.

5. The carrying bag of claim 1 wherein said main carrying bag housing has a closeable sub-storage enclosure for storing said solar power storing and recharging system within said inside storage compartment.

6. The carrying bag of claim 1 wherein said keyhole includes a flashing option with a corresponding flashing switch.

7. A carrying bag, which comprises:
a) a main carrying bag housing having a top, a bottom, a front, a back, a left side and a right side, and having an inside storage compartment and having an access opening to said inside storage compartment;
b) a solar panel located on an outside area of said main carrying bag housing and wiring from said solar panel to a solar power storing and recharging system located within said inside storage compartment;
c) said solar power storing and recharging system located within said storage compartment having at least a voltage regulator and a storage battery, said storage battery and voltage regulator having sufficient capacity and voltage regulation for charging a cell phone and for powering a keyhole light;
d) at least one cell phone connection wire and adaptor for recharging a cell phone, said wire and adaptor connected to said solar power storing and recharging system and located within said inside storage compartment;
e) a keyhole light connected to said solar storing and recharging system and connected to said main carrying bag housing and having on/off switch, said keyhole light being located in a functional position selected from the group consisting of (i) fixed within said main carrying bag housing so that light is directed outwardly therefrom; and (ii) removably stored for manual use;
f) an alarm connected to said solar storing and recharging system and connected to said main carrying bag housing and having on/off switch for activation and deactivation.

8. The carrying bag of claim 7 wherein said keyhole light is an LED light.

9. The carrying bag of claim 7 wherein said adaptor is a plurality of interchangeable adaptors for a variety of different cell phone charger connections.

10. The carrying bag of claim 7 wherein said carrying bag is selected from the group consisting of a pocketbook, a briefcase, a belt pouch, a beach bag and a backpack.

11. The carrying bag of claim 7 wherein said main carrying bag housing has a closeable sub-storage enclosure for storing said solar power storing and recharging system within said inside storage compartment.

12. The carrying bag of claim 7 wherein said keyhole includes a flashing option with a corresponding flashing switch.

13. The carrying bag of claim 7 wherein said alarm is a sounding alarm and includes a speaker.

14. The carrying bag of claim 7 wherein said alarm is a visual alarm that includes at least one feature selected from the group consisting of colored light, flashing light and combinations thereof.

15. The carrying bag of claim 7 wherein said alarm is a visual and sounding alarm that includes at least one feature selected from the group consisting of colored light, flashing light and combinations thereof and includes a speaker.

16. The carrying bag of claims wherein said alarm activation switch is activated with a time delay by opening said access opening of said housing without timely deactivating said alarm.
